(19) United States
(12) Patent Application Publication
(10) Pub. No.: US 2015/0199757 A1
(43) Pub. Date: Jul. 16, 2015

(54) USER CONFIGURABLE TRADE LINE REPORTING AND SCORING

(71) Applicant: eCredable.com, LLC, Alpharetta, GA (US)

(72) Inventors: Terron Roy Lindholme, Burien, WA (US); Robert McCutchen Moore, Suwanee, GA (US); Steven Paul Ely, Roswell, GA (US)

(21) Appl. No.: 14/579,547

(22) Filed: Dec. 22, 2014

Related U.S. Application Data
(60) Provisional application No. 61/927,335, filed on Jan. 14, 2014.

(51) Int. Cl. G06Q 40/02; G06Q 40/00

(52) U.S. Cl. CPC G06Q 40/025; G06Q 40/12

(57) ABSTRACT

Disclosed are various embodiments for a payment verification application executable in a computing environment having a hardware processor configured to obtain payment history data for a user of a client device over a network. The payment history data may comprise information associated with a plurality of payments made by the user to an entity. Further, the payment verification application verifies the payments to ensure that each of the plurality of payments satisfied an obligation owed to the entity by the user and generates a reporting document comprising at least the plurality of payments verified. The reporting document is electronically transmitted over a network to a receiving computing device via a web service.

### CROSS-REFERENCE TO RELATED APPLICATION

This application claims the benefit of and priority to co-pending U.S. Provisional Patent Application Ser. No. 61/927,335 entitled “USER CONFIGURABLE TRADE LINE REPORTING AND SCORING,” filed Jan. 14, 2014, which is incorporated by reference herein in its entirety.

### BACKGROUND

With respect to consumer credit reporting, scoring, and consumer protection, the common wisdom was that individuals could build a good credit history and score by paying their bills on time, and that consumer credit reports and scores from major bureaus, such as EQUIFAX®, EXPERIAN®, and TRANSUNION®, provide a complete and accurate picture of an applicant's creditworthiness. The reality is that credit reporting is “voluntary” under the Fair Credit Reporting Act (FCRA) in the United States and potentially other countries. This is to say that creditors may report to a credit bureau, but they are not required to do so by law.

Many creditors, debit card companies, and general purpose reloadable (GPR) card companies choose not to report to credit bureaus and many are too small for the major bureaus to trust them as reliable and regular monthly data sources. Similarly, landlords, used car dealers, utility, phone, and insurance companies do not report to credit bureaus, unless payments are late. Virtually most credit reports and scores are missing positive account payment histories from the aforementioned sources. This condition causes tens of millions of adult consumers to have scores that, in many cases, are lower than they should be or are completely absent of a score, causing them to be denied and/or charged more for housing, credit, insurance, utilities, and employment. Consumers are prevented from accessing credit from mainstream lenders, from building assets, and from securing their financial futures—jeopardizing the financial security of all consumers.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 illustrates a payment verification application in communication with a data store according to various embodiments of the present disclosure.

FIG. 2 illustrates a networked environment comprising the payment verification application according to various embodiments of the present disclosure.

FIG. 3 illustrates an example workflow of the networked environment of FIG. 2 according to various embodiments of the present disclosure.

FIG. 4 illustrates an example user interface rendered by a client in the networked environment of FIG. 2 according to various embodiments of the present disclosure.

FIG. 5 illustrates an example user interface rendered by a client in the networked environment of FIG. 2 according to various embodiments of the present disclosure.

FIG. 6 illustrates an example reporting document generated by the payment verification application in the networked environment of FIG. 2 according to various embodiments of the present disclosure.

FIG. 7 is a flowchart illustrating one example of functionality implemented as portions of the payment verification application executed in a computing environment in the networked environment of FIG. 2 according to various embodiments of the present disclosure.

FIG. 8 is a schematic block diagram that provides one example illustration of a computing environment employed in the networked environment of FIG. 2 according to various embodiments of the present disclosure.

### DETAILED DESCRIPTION

The present disclosure relates to a payment verification application, executable in a computing environment, configured to allow consumers to report positive credit transactions to major credit bureaus. As discussed above, the common wisdom was that individuals could build a good credit history and score by paying their bills on time, and that consumer credit reports and scores from major bureaus, such as EQUIFAX®, EXPERIAN®, and TRANSUNION®, provide a complete and accurate picture of an applicant's creditworthiness. The reality is that credit reporting is “voluntary” under the Fair Credit Reporting Act (FCRA) in the United States and potentially other countries. This is to say that creditors may report to a credit bureau, but they are not required to do so by law.

Many creditors, debit card companies, and general purpose reloadable (GPR) card companies choose not to report to credit bureaus and many are too small for the major bureaus to trust them as reliable and regular monthly data sources. Similarly, landlords, used car dealers, utility, phone, insurance companies, etc., do not report to credit bureaus, unless payments are late. Virtually most credit reports and scores are missing positive account payment histories from the aforementioned sources. This condition causes tens of millions of adult consumers to have scores that, in many cases, are lower than they should be or are completely absent of a score, causing them to be denied and/or charged more for housing, credit, insurance, utilities, and employment. Consumers are prevented from accessing credit from mainstream lenders, from building assets, and from securing their financial futures, thereby jeopardizing the financial security of the consumers.

In the most cases, where consumers' financial accounts and on-time payment histories are not reported to, nor on record with a bureau, consumers have the right in the United States, under the Equal Credit Opportunity Act (ECOA) Section 202.6(b)(6), to “voluntarily” self-report their missing accounts and payment histories directly with applications they submit that require a credit check. This allows the consumer to fairly demonstrate their creditworthiness. Whether it be for an apartment, mortgage, credit card, auto loan, student loan, business loan, insurance, utility and phone service, or employment the consumer-supplied supplemental information must be considered by a creditor according to this federal law.

It remains difficult to enable consumers to voluntarily supply independently audited and certified personal and account information with an application, or to EQUIFAX®, EXPERIAN®, and TRANSUNION®, or into the credit scoring engines used by their customers. For example, a consumer is not able to provide receipts, paid utility bills, or accounting statements to the major credit bureaus, as doing so would be too burdensome for the major credit bureaus to manage for the vast number of consumers.

Accordingly, it is beneficial for a payment verification application, executable in a computing environment, to be configured to allow consumers to report positive credit transactions to major credit bureaus on behalf of a user (i.e., a consumer) of a client device. To this end, the payment verification application may access a first application programming interface (API) offered by an entity (e.g., a utility company, a car dealership, etc.) over a network to obtain payment history data for the user of the client device. The payment history data may comprise at least information associated with payments made by the user to the entity.

Further, the payment verification application may generate a user interface to send to the client device comprising at least the payments received from the entity. Via the user interface, the payment verification application may receive user input comprising a selection of a subset of the payments. The subset of the payments selected via the user interface may be authenticated or verified to ensure each of the plurality of payments in the subset satisfies an obligation owed to the entity by the user in whole or in part.

Ultimately, a reporting document comprising at least the subset of the plurality of payments authenticated or verified may be generated by the payment verification application. The reporting document may be electronically transmitted to credit bureaus using one or more APIs, as will be discussed in greater detail below. In the following discussion, a general description of the system and its components is provided, followed by a discussion of the operation of the same.

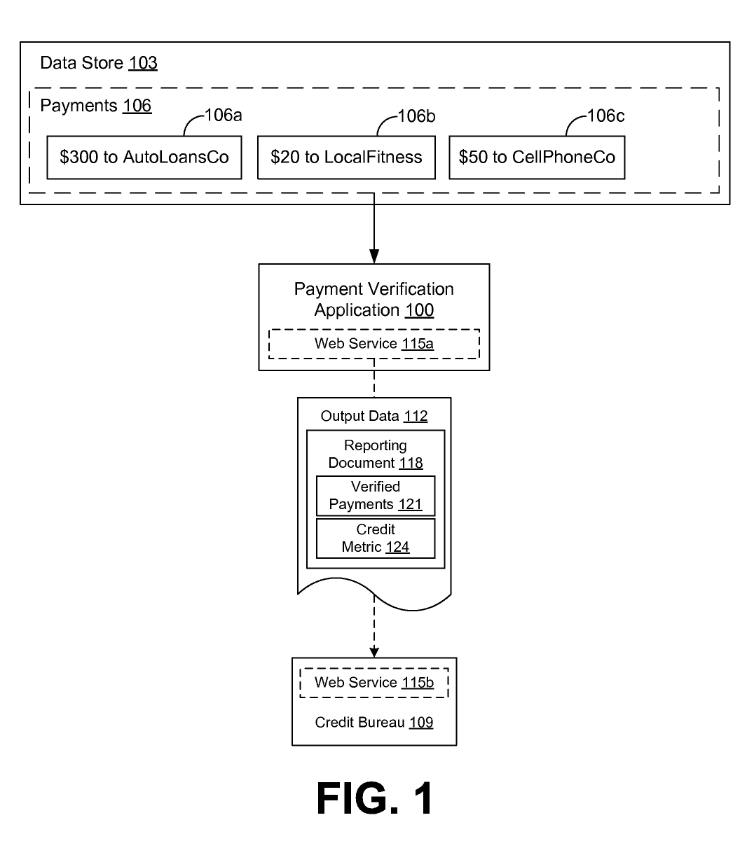

With reference to FIG. 1, shown is a relationship between a payment verification application 100 and a data store 103 (e.g., a remote or local database residing in computer memory) according to various embodiments of the present disclosure. As shown in FIG. 1, the data store 103 may comprise one or more payments 106 that may be associated with a particular user of the payment verification application 100. For example, the payments 106 shown in FIG. 1, may comprise data associated with a $300 payment made to “AutoLoansCo” (e.g., payment 106a), a $20 payment made to “LocalFitness” (e.g., payment 106b), and a $50 payment made to “CellPhoneCo” (e.g., payment 106c).

As may be appreciated, the payment verification application 100 communicates with the data store 103 to access the payments 106 on behalf of a user or on behalf of a plurality of users to verify and report the payments 106 to a computing device associated with a credit bureau 109. To this end, the payment verification application 100 may send output data 112 via an electronic form of communication from a first application programming interface (e.g., a first web service 115a) associated with the payment verification application 100 to a second application programming interface (e.g., a second web service 115b) associated with the credit bureau 109, as will be described in greater detail below. According to various embodiments, the output data 112 may comprise a reporting document 118 generated by the payment verification application 100 to facilitate an interpretation of the payments 106 by the credit bureau 109 or by the computing device associated with the credit bureau 109.

Consequently, the reporting document 118 may comprise the payments 106 verified by the payment verification application 100 (hereinafter verified payments 121) and a credit metric 124 determined by the payment verification application 100. According to various embodiments, the credit metric 124 may comprise, for example, a proprietary credit metric 124 associated with an operator of the payment verification application 100.

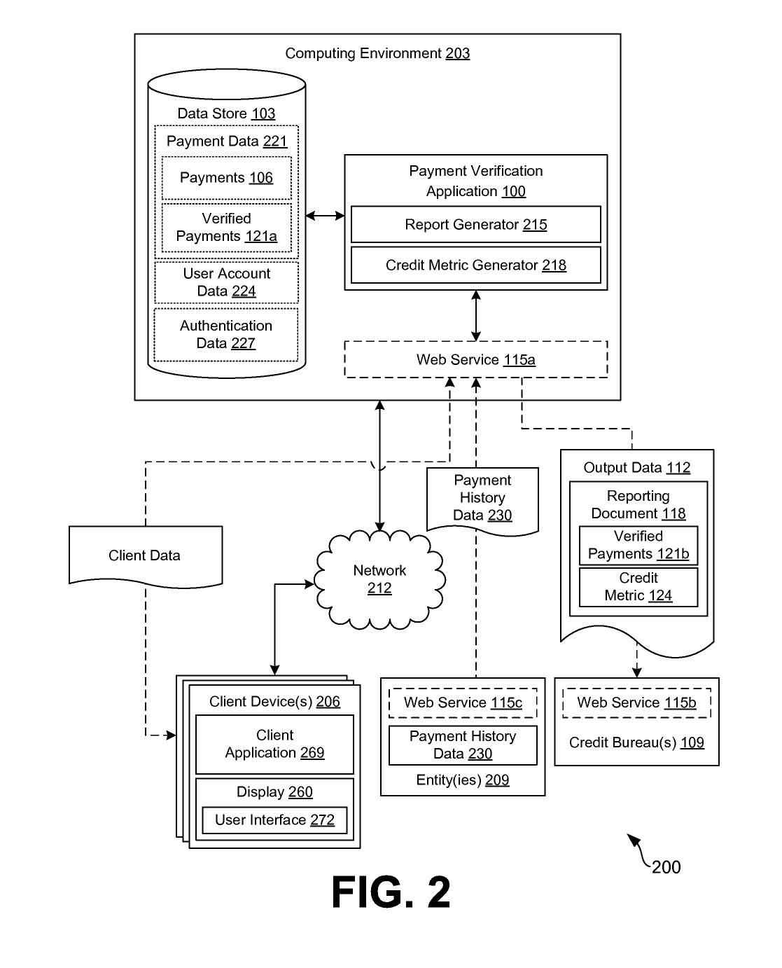

With reference to FIG. 2, shown is a networked environment 200 according to various embodiments. The networked environment 200 includes a computing environment 203, a client device 206, an entity computing device (hereinafter entity 209), and a credit bureau computing device (hereinafter credit bureau 109), which are in data communication with each other via a network 212. The network 212 includes, for example, the Internet, intranets, extranets, wide area networks (WANs), local area networks (LANs), wired networks, wireless networks, or other suitable networks, etc., or any combination of two or more such networks. For example, such networks may comprise satellite networks, cable networks, Ethernet networks, and other types of networks.

The computing environment 203 may comprise, for example, a server computer or any other system providing computing capability. Alternatively, the computing environment 203 may employ a plurality of computing devices that may be arranged, for example, in one or more server banks or computer banks or other arrangements. Such computing devices may be located in a single installation or may be distributed among many different geographical locations. For example, the computing environment 203 may include a plurality of computing devices that together may comprise a hosted computing resource, a grid computing resource, and/or any other distributed computing arrangement. In some cases, the computing environment 203 may correspond to an elastic computing resource where the allotted capacity of processing, network, storage, or other computing-related resources may vary over time.

Various applications and/or other functionality may be executed in the computing environment 203 according to various embodiments. Also, various data is stored in a data store 103 that is accessible to the computing environment 203. The data store 103 may be representative of a plurality of data stores 103 as can be appreciated. The data stored in the data store 103, for example, is associated with the operation of the various applications and/or functional entities described below.

The components executed on the computing environment 203, for example, include the payment verification application 100, a report generator 215, a credit metric generator 218, and other applications, services, processes, systems, engines, or functionality not discussed in detail herein. According to various embodiments, the report generator 215 and the credit metric generator 218 may be implemented as applications, programs, services, or modules separate from the payment verification application 100.

The payment verification application 100 is executed to collect financial information associated with a consumer, verify payments made by the consumer, and submit verified payments to one or more credit bureaus 109. The payment verification application 100 also performs various backend functions associated with a collection and maintenance of financial information associated with a consumer in order to facilitate the verification and submission of positive payment information as will be described. For example, the payment verification application 100 generates network pages such as web pages or other types of network content that are provided to client devices 206 for the purposes of collecting financial information associated with a user, verifying payments made by the user, and submitting verified payments to one or more credit bureaus 109.

The report generator 215 is executed to generate the reporting document 118 that may comprise, for example, the payments 106 selected by the user and verified by the payment verification application 100. The credit metric generator 218 is executed to generate a proprietary credit score based on the financial information provided by the user. According to various embodiments, a credit metric (e.g., a credit score) generated by the credit metric generator 218 may be included in the reporting document 118 for submission to one or more credit bureaus 109.

The data stored in the data store 103 includes, for example, payment data 221, user account data 224, authentication data 227, and potentially other data. To this end, payment data 221 may comprise information associated with one or more payments 106 made by a user to an entity 209. This information may include a date a payment 106 was made, an amount of the payment 106, whether the payment satisfied an obligation owed by the user to the entity 209 in whole or in part, and/or other information. Payment data 221 may further comprise verified payments 121a which includes payments 106 verified by the payment verification application 100 as being made by the user and/or satisfying an obligation owed by the user to the entity 209.

User account data 224 includes information used to authenticate a user such as the information used by the user to access the payment verification application 100 (e.g., biometric data, username, and password). The authentication data 227 includes information provided by the user that is used to access financial information associated with the user from one or more entities 209. To this end, the authentication data 227 may include account data for the user associated with the entity 209. As a non-limiting example, the user may provide a username and a password to the payment verification application 100 associated with an account for a Natural Gas Company. Using the username and password, the payment verification application 100 may access the payment history for the user from the Natural Gas Company.

The client device 206 is representative of one or more client devices 206 that may be coupled to the network 212. The client device 206 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability. The client device 206 may include a display 260. The display 260 may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client device 206 may be configured to execute various applications such as a client application 269 and/or other applications. The client application 269 may be executed in a client device 206, for example, to access network content served up by the computing environment 203 and/or other servers, thereby rendering a user interface 272 on the display 260. To this end, the client application 269 may comprise, for example, a browser, a dedicated application, etc., and the user interface 272 may comprise a network page, an application screen, etc. The client device 206 may be configured to execute applications beyond the client application 269 such as, for example, email applications, social networking applications, word processors, spreadsheets, and/or other applications.

Next, a general description of the operation of the various components of the networked environment 200 is provided. To begin, it is assumed that a consumer, as a user of the client device 206, accesses the payment verification application 100 to report positive credit or payment transactions to one or more credit bureaus 109, such as EQUIFAX®, EXPERIAN®, and TRANSUNION®. Accordingly, a user may create a client account in the payment verification application 100 allowing the user to securely store personal and financial information that may be used to report positive payment history to the credit bureaus 109. Further, the user may associate his or her account with an entity 209, such as a utility company, a credit card company, a banking or lending institution, a brokerage firm, an insurance company, a payment aggregation service (e.g., MINT.COM®), etc. Upon associating the entity 209 with the user account, the user may be required to submit authentication data 227 for the entity to the payment verification application 100 which may then use the authentication data 227 to obtain payment history data 230 corresponding to the user.

Accordingly, a web service 115c or other application programming interface of the entity 209 provided by the user is accessed by the payment verification application 100 to obtain the payment history data 230 for a user. According to various embodiments, the web service 115c may be accessed by the payment verification application 100 by making a programmatic service call, such as an API call requesting the payment history data 230. According to various embodiments, the API call may comprise a simple object access protocol (SOAP) service call or a representational state transfer (REST) service call.

The payment history data 230, obtained from the entity 209, may comprise one or more payments 106 made by the user to the entity 209. The payment verification application 100 may generate one or more user interfaces 272 configured to prompt the user with the payments 106 accessed from the entity 209 (as well as payments 106 access from other entities 209). The payment verification application 100 may receive user input comprising a selection of all or a subset of the payments 106 to submit to one or more predefined credit bureaus 109.

For example, the user may select which payments to verify and/or to include in the reporting document 118 to be electronically submitted to at least one of the credit bureaus 109. The payments selected by the user in the user interface 272 are “verified” to determine whether an obligation owed to the entity 209 has been satisfied. As a non-limiting example, a payment 106 of $25 may be made by a user to a gas utility company to pay a $35 bill. The payment verification application 100 may determine that the $25 payment 106 did not completely satisfy an obligation owed to the gas utility company as there is a balance of $10.00. Similarly, a payment of $1,000 may be made by a user to a loan company to pay off a $1,000 note. The payment verification application 100 may determine that the $1,000 payment completely satisfies the obligation owed to the loan company as there is no remaining balance.

According to various embodiments, verification of a payment 106 may be manual, requiring an action by a person, or performed automatically by the payment verification application 100. Manual verification may comprise, for example, electronically generating a report for a verification employee to initiate a three-way call among the verification employee, the requesting user, and the particular entity 209. The report may be electronically transmitted to the verification employee via electronic mail, instant message, SMS, etc., or provided in a user interface 272 accessible by the verification employee. The report may comprise a contact number of the requesting user as well as a contact number of the particular entity 209. Upon a confirmation by the particular entity 209, verbal or written, the verification employee, via the payment verification application 100, may change a status of the payment from “unverified” to “verified,” via a user interface-driven database or a similar component.

Alternatively, automatic verification may comprise, for example, electronically communicating with the particular entity 209 via an API or a similar medium of communication to verify whether a payment was actually made and/or satisfies an obligation owed to the particular entity 209. This may be accomplished, for example, by the employing the authentication data 227 associated with the entity 209 provided by the user. Upon an electronic confirmation by the particular entity 209, the payment verification application 100 may change a status of the payment from “unverified” to “verified.”

If all of the payments (or if a portion of the payments exceeding a threshold predefined by an administrator of the payment verification application 100) have been verified, the reporting document 118 is generated comprising at least the verified payments 121b selected by the user in the subset by the report generator 215. The reporting document 118 may further comprise information associated with the submitting user, such as a legal name, address, social security number, and any contact information. Further, the reporting document 118 may comprise a detailed and/or itemized list of the subset of the verified payments 121b selected by the user. In various embodiments, the reporting document 118 further comprises the credit metric 124 determined by the credit metric generator 218 or the payment verification application 100. According to various embodiments, the credit metric 124 may comprise, for example, a proprietary credit metric 124 associated with an operator of the payment verification application 100.

Ultimately, output data comprising the reporting document 118, having at least the verified payments, is electronically transmitted to one or more credit bureaus 109 via a web service 115b or similar method from a web service 115a of the computing environment 203. According to various embodiments, the user may subsequently access the generated reporting document 118 and/or may approve the generated reporting document 118 prior to a transmission to the credit bureau 109.

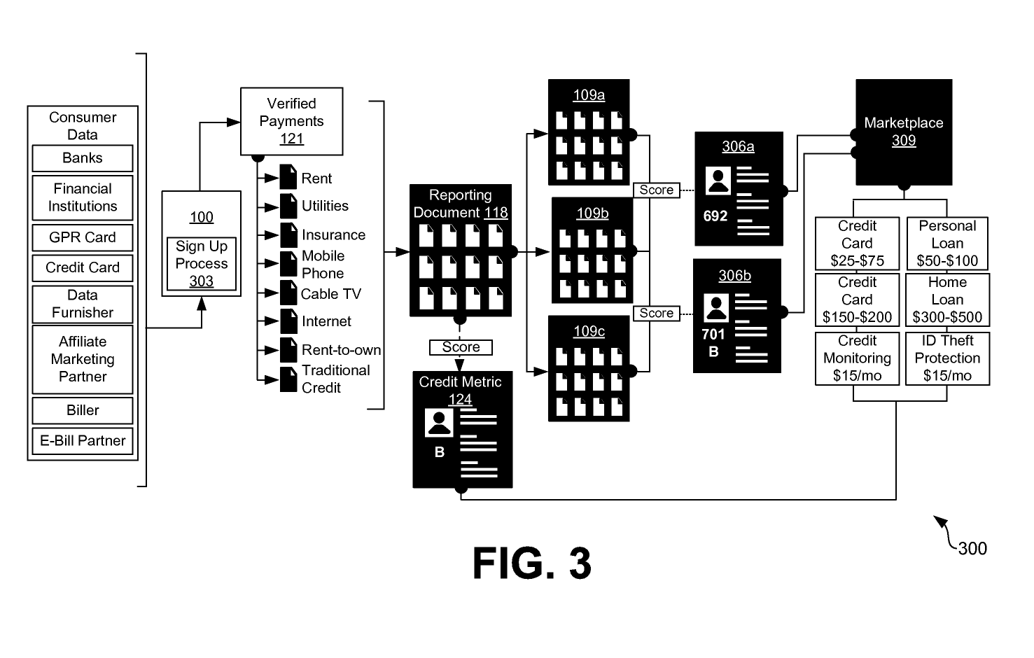

Referring next to FIG. 3, shown is an example process 300 in which a consumer (e.g., a user of the client device 206 of FIG. 2) submits one or more payments 106 to one or more credit bureaus 109a . . . c. As may be appreciated, a consumer, in his or her daily activities, may make purchases, deposits, or pay bills. The financial information, in the form of payment history data 230, may be obtained from one or more entities 209 (FIG. 2) such as banks, financial institutions, GPR card companies, credit card companies, data furnishing companies, affiliate marketing partners, electronic billing companies, etc., and coalesced by the payment verification application 100.

The consumer may participate in a sign-up process 303 to access the payment verification application 100. According to various embodiments, the sign-up process 303 requires the user to provide user account data 224 such as a name, a contact number, an address, an e-mail address, a social security number, and/or another identifier that may be used by the credit bureaus 109 to identify the consumer. The payment verification application 100 verifies payments 106 selected by the consumer that the consumer wishes to report to the credit bureaus 109.

Accordingly, the payment verification application 100 determines one or more verified payments 121 to include in a reporting document 118. According to various embodiments, a credit metric 124 may be determined for the user. The credit metric 124 may use a formula proprietary to an operator of the payment verification application 100, as may be appreciated. The reporting document 118 is transmitted electronically to the credit bureaus 109 such as EQUIFAX®, EXPERIAN®, TRANSUNION®, and/or any other credit bureau 109.

As may be appreciated, the credit bureaus 109a . . . 109c use the positive payments 106 submitted by the user in generating a credit score 306a . . . 306b (collectively credit scores 306), such as a FICO® score and a VANTAGESCORE®. These credit scores 306 affect the consumer positively in a marketplace 309 by assisting with interest rates, loan terms, etc.

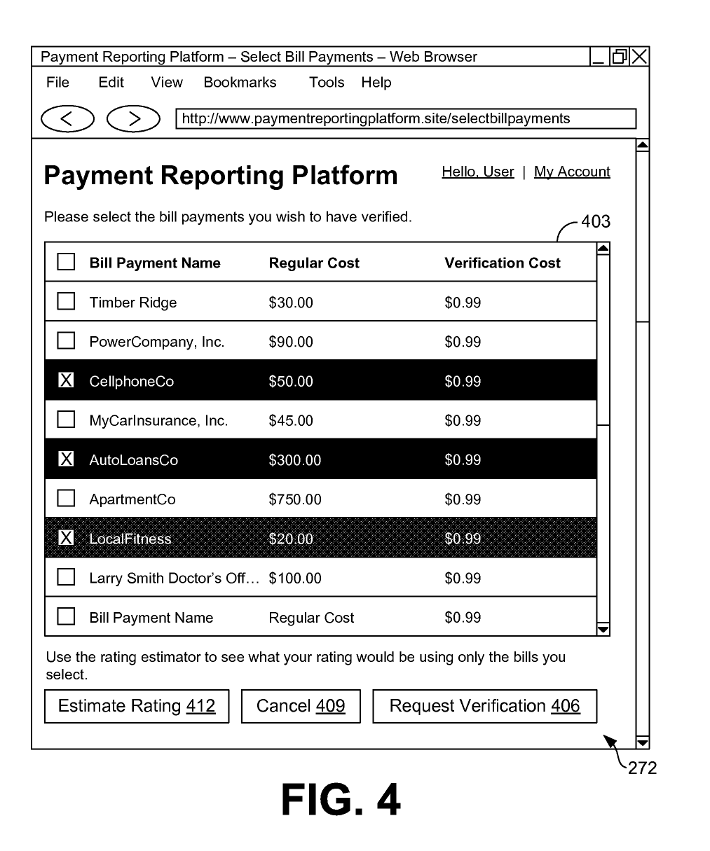

Turning now to FIG. 4, shown is a non-limiting example of a user interface 272 generated by the payment verification application 100 (FIG. 1) according to various embodiments of the present disclosure. In the non-limiting example of FIG. 4, a plurality of payments 106 are shown in a table 403 allowing the user, via the user interface 272 and the components provided, to select a subset of the payments 106 to report to one or more credit bureaus 109. As may be appreciated, the subset may include all or a portion of the payments 106 presented to the user.

In the non-limiting example of FIG. 4, the user has engaged the payments 106 corresponding to a $50 payment made to “CellPhoneCo,” a $300 payment made to “AutoLoansCo,” and a $20 payment made to “LocalFitness.” The payments 106 shown in the table 403 may be accessed from one or more web services associated with one or more entities 209. For example, the $20 payment made to “LocalFitness” may be accessed from a web service associated with and/or operated by LocalFitness. In alternative embodiments, the $20 payment made to “LocalFitness” may be accessed from a payment aggregation service (e.g., MINT.COM®) or from a credit card or debit card institution.

By engaging a request verification component 406, the subset of the payments 106 selected by the user in the user interface 272 may be verified by the payment verification application 100. Alternatively, the user may engage the cancel component 409 to terminate verification of the payments 106 and/or submission of the payments 106 to one or more credit bureaus 109. In various embodiments, the user may engage an estimate rating component 412 prior to requesting verification of the payments 106 or submitting the selected payments 106 to a credit bureau 109. By doing so, the user may determine whether a submission of the selected payments 106 will positively or negatively impact the user's credit score or may determine whether a submission of the selected payments 106 will not make a noticeable impact on the user's credit score.

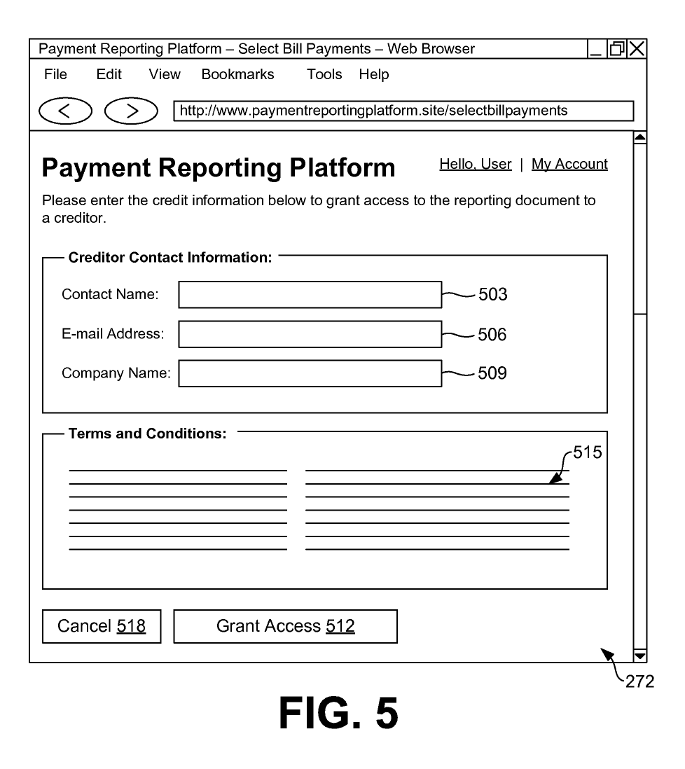

Moving on to FIG. 5, shown is a non-limiting example of a user interface 272 generated by the payment verification application 100 (FIG. 1) according to various embodiments of the present disclosure. In the non-limiting example of FIG. 5, the user interface 272 shown is generated by the payment verification application 100 to facilitate sharing financial information with an institution on behalf of the user. As discussed above, the reporting document 118 (FIG. 1) may comprise information associated with one or more payments 106 selected by the user and verified by the payment verification application 100. The user may desire to share the reporting document 118 (or associated information) with one or more credit bureaus 109 and/or any other institution. To this end, the user may enter information associated with a particular credit bureau 109 or a particular institution. In the non-limiting example of FIG. 5, the information may be provided by the user by employing a contact name component 503, an e-mail address component 506, and/or a company name component 509.

Using the information provided via the components of the user interface 272, the reporting document 118 may be electronically transmitted to the e-mail address provided by the user. In various embodiments, the reporting document 118 may be printed and mailed to the institution. In yet another embodiment, the reporting document 118 may be made accessible to the institution provided over the payment verification application 100. To this end, the reporting document 118 (or associated information) may be accessed over the network 212 (FIG. 2) via a uniform resource locator (URL). Access to payment information associated with the user is controlled by the user. Accordingly, the user initiates a granting of access using the grant access component 512 after acknowledging any associated terms and conditions 515. Alternatively, the user may terminate the process of granting access to the user's financial information by engaging the cancel component 518.

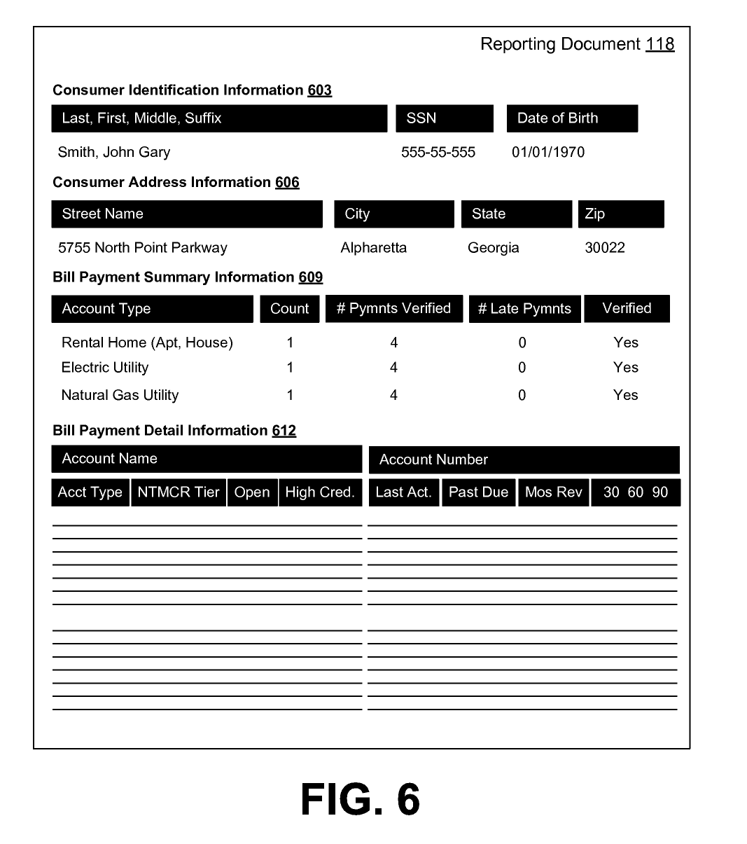

Moving on to FIG. 6, shown is a non-limiting example of the reporting document 118 generated by the payment verification application 100 (FIG. 1) according to various embodiments of the present disclosure. As discussed above, the reporting document 118 may comprise financial information associated with the user that may be used by one or more of the credit bureaus 109 to impact or improve the user's credit score and/or credit history. According to various embodiments, the reporting document 118 contains the payments 106 selected by the user and verified by the payment verification application 100.

Further, the reporting document 118 may comprise consumer identification information 603 such as a first name, a last name, a middle name, a suffix, a social security number, a tax identification number, a date of birth, and/or other information that may identify the consumer. The reporting document 118 may further comprise consumer address information 606 that may include a street name, a city, a state, and a zip that may be used in contacting the consumer and/or verifying consumer information.

Bill payment summary information 609 may be generated by the payment verification application 100 and included in the reporting document 118 in various embodiments. As shown in FIG. 6, the bill payment summary information 609 may comprise a summary of the type of accounts associated with payments 106 selected by the user and verified by the payment verification application 100. Further, the summary may include a count of the number of accounts associated with a particular category (e.g., Rental Home, Electric Utility, Natural Gas Utility), the number of payments 106 verified, the number of late payments, whether the payments 106 were actually verified, how the payments 106 were verified (e.g., automatically or manually), etc.

Bill payment detail information 612 may include in-depth information associated with the payments 106 selected by the user and verified by the payment verification application 100. According to various embodiments, the reporting document 118 may comprise a viewable electronic document such as a word processing file (DOC), a spreadsheet processing file (XCL), a rich text file (RTF), a text file (TXT), portable document file (PDF), and/or any similar file. In various embodiments, the reporting document 118 may comprise information sent to a receiving computing device in a data structure, a transmission frame, and/or a data packet.

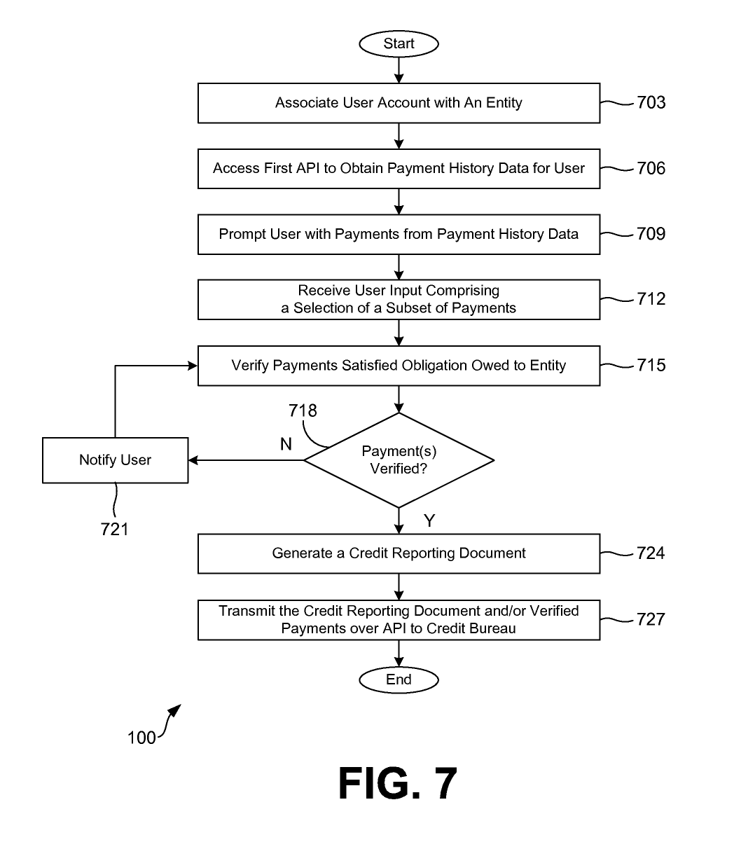

Referring next to FIG. 7, shown is a flowchart that provides one example of the operation of a portion of the payment verification application 100 according to various embodiments. It is understood that the flowchart of FIG. 7 provides merely an example of the many different types of functional arrangements that may be employed to implement the operation of the portion of the payment verification application 100 as described herein. As an alternative, the flowchart of FIG. 7 may be viewed as depicting an example of elements of a method implemented in the computing environment 203 (FIG. 2) according to one or more embodiments.

As discussed above, a consumer may engage the payment verification application 100 via the client device 206 (FIG. 2) to report positive credit transactions to major credit bureaus. Beginning with 703, a user may access the payment verification application 100 to associate a user account in the payment verification application 100 (corresponding to the user) with an entity, such as a utility company, a credit card company, a banking or lending institution, a brokerage firm, an insurance company, a payment aggregation service (e.g., MINT.COM®), etc. To this end, the user may be required to submit authentication data for the entity to the payment verification application 100 which may then use the authentication data to obtain payment history data 230 corresponding to the user.

In 706, a first API of the entity provided by the user is accessed by the payment verification application 100 to obtain the payment history data 230 for a user. According to various embodiments, the first API may be accessed by the payment verification application 100 by making a programmatic service call, such as an API call requesting the payment history data 230. Similarly, the payment history data 230 may be obtained via the web service 115 over the network 212.

The payment history data 230, accessed from a particular entity, may comprise one or more payments made by the user to the particular entity. In various embodiments, the user may be prompted with payments obtained from a first entity that are coalesced with payments obtained from other entities. In 709, a user may be prompted with one or more payments set forth in the payment history data 230. According to various embodiments, the user may be prompted with the one or more payments in a user interface 272 similar to the non-limiting example of FIG. 4. However, in various embodiments, the user may be presented with payments via a simple message service (SMS), electronic mail, instant message, etc.

Next, in 712, the payment verification application 100 may receive user input comprising a selection of all or a subset of the payments. For example, the user may select which payments to verify and/or to include in a reporting document to be electronically submitted to at least one of the credit bureaus. In 715, the payments selected by the user in 712 are “verified” to determine whether an obligation owed to the entity is satisfied. As a non-limiting example, a payment of $75 may be made by a user to an electric utility company to pay a $80 bill. The payment verification application 100 may determine that the $75 did not completely satisfy an obligation owed to the electric utility company as there is a balance of $5.00. Similarly, a payment of $100 may be made by a user to an electric utility company to pay a $100 bill. The payment verification application 100 may determine that the $100 payment completely satisfies the obligation owed to the electric utility company as there is no remaining balance.

According to various embodiments, verification may be manual, requiring an action by a person, or performed automatically by the payment verification application 100. Manual verification may comprise, for example, electronically generating a report for a verification employee to initiate a three-way call among the verification employee, the requesting user, and the particular entity. The report may be electronically transmitted to the verification employee via electronic mail, instant message, SMS, etc., or provided in a user interface 272 accessible by the verification employee. The report may comprise a contact number of the requesting user as well as a contact number of the particular entity. Upon a confirmation by the particular entity, verbal or written, the verification employee, via the payment verification application 100, may change a status of the payment from “unverified” to “verified,” via a user interface-driven database or a similar component.

Alternatively, automatic verification may comprise, for example, electronically communicating with the particular entity via an API or a similar medium of communication to verify whether a payment was actually made and/or satisfies an obligation owed to the particular entity. This may be accomplished, for example, by the employing the authentication data associated with the entity provided by the user. Upon an electronic confirmation by the particular entity, the payment verification application 100 may change a status of the payment from “unverified” to “verified.”

Accordingly, in 718, it is determined whether the payments selected by the user in the subset have been verified. The determination may be made based at least in part on the status of the payment (e.g., “verified” or “unverified”). If one or more of the payments are unverified, in 721, the user may be notified to either (a) remove the unverified payment(s) from the selected subset or (b) attempt another verification of the unverified payment(s). If the user attempts another verification of the unverified payment(s) the process proceeds to 715, as may be appreciated.

If all of the payments (or if a portion of the payments exceeding a threshold predefined by an administrator of the payment verification application 100) have been verified, in 724, a reporting document may be generated comprising at least the one or more payments selected by the user in the subset. The reporting document may further comprise information associated with the submitting user, such as a legal name, address, social security number, and any contact information. Further, the reporting document may comprise a detailed and/or itemized list of the subset of the verified payments selected by the user.

According to various embodiments, the reporting document may resemble a document similar to the reporting document 118 shown in FIG. 6. However, in various embodiments, the reporting document may assume the form of a data packet or a file for electronic transmission to a credit bureau via an API.

Ultimately, in 727, the reporting document, comprising at least the verified payments, is electronically transmitted to one or more credit bureaus. According to various embodiments, the user may subsequently access the generated reporting document and/or may approve the generated reporting document prior to a transmission to the credit bureau.

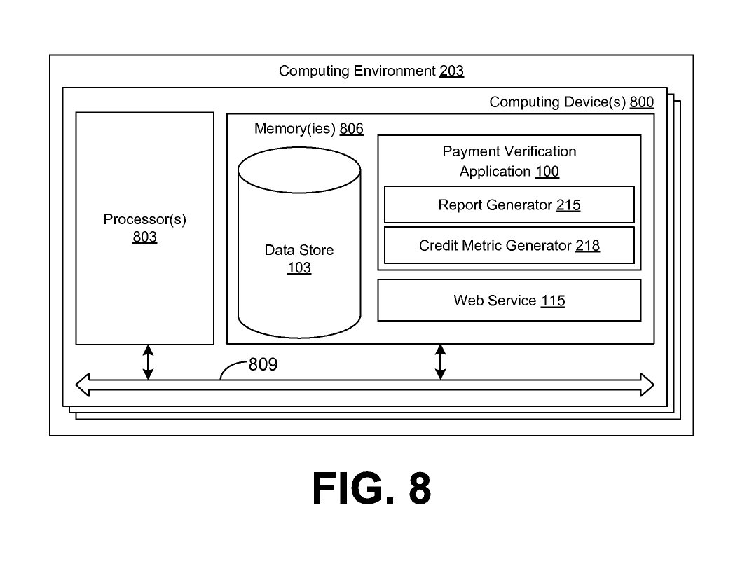

With reference to FIG. 8, shown is a schematic block diagram of the computing environment 203 according to an embodiment of the present disclosure. The computing environment 203 includes one or more computing devices 800. Each computing device 800 includes at least one processor circuit, for example, having a processor 803 and a memory 806, both of which are coupled to a local interface 809. To this end, each computing device 800 may comprise, for example, at least one server computer or like device. The local interface 809 may comprise, for example, a data bus with an accompanying address/control bus or other bus structure as can be appreciated.

Stored in the memory 806 are both data and several components that are executable by the processor 803. In particular, stored in the memory 806 and executable by the processor 803 are the payment verification application 100, the report generator 215, the credit metric generator 218, the web service 115, and potentially other applications. Also stored in the memory 806 may be a data store 103 and other data. In addition, an operating system may be stored in the memory 806 and executable by the processor 803.

It is understood that there may be other applications that are stored in the memory 806 and are executable by the processor 803 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 806 and are executable by the processor 803. In this respect, the term “executable” means a program file that is in a form that can ultimately be run by the processor 803. Examples of executable programs may be, for example, a compiled program that can be translated into machine code in a format that can be loaded into a random access portion of the memory 806 and run by the processor 803, source code that may be expressed in proper format such as object code that is capable of being loaded into a random access portion of the memory 806 and executed by the processor 803, or source code that may be interpreted by another executable program to generate instructions in a random access portion of the memory 806 to be executed by the processor 803, etc. An executable program may be stored in any portion or component of the memory 806 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 806 is defined herein as including both volatile and nonvolatile memory and data storage components. Volatile components are those that do not retain data values upon loss of power. Nonvolatile components are those that retain data upon a loss of power. Thus, the memory 806 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 803 may represent multiple processors 803 and/or multiple processor cores and the memory 806 may represent multiple memories 806 that operate in parallel processing circuits, respectively. In such a case, the local interface 809 may be an appropriate network that facilitates communication between any two of the multiple processors 803, between any processor 803 and any of the memories 806, or between any two of the memories 806, etc. The local interface 809 may comprise additional systems designed to coordinate this communication, including, for example, performing load balancing. The processor 803 may be of electrical or of some other available construction.

Although the payment verification application 100, the report generator 215, the credit metric generator 218, the web service 115, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart of FIG. 7 shows the functionality and operation of an implementation of portions of the payment verification application 100, the report generator 215, and/or the credit metric generator 218. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 803 in a computer system or other system. The machine code may be converted from the source code, etc. If embodied in hardware, each block may represent a circuit or a number of interconnected circuits to implement the specified logical function(s).

Although the flowchart of FIG. 7 shows a specific order of execution, it is understood that the order of execution may differ from that which is depicted. For example, the order of execution of two or more blocks may be scrambled relative to the order shown. Also, two or more blocks shown in succession in FIG. 7 may be executed concurrently or with partial concurrence. Further, in some embodiments, one or more of the blocks shown in FIG. 7 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the payment verification application 100, the report generator 215, the credit metric generator 218, the web service 115, that comprises software or code can be embodied in any non-transitory computer-readable medium for use by or in connection with an instruction execution system such as, for example, a processor 803 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the payment verification application 100, the report generator 215, the credit metric generator 218, the web service 115, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 800, or in multiple computing devices in the same computing environment 203. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A non-transitory computer-readable medium embodying a program executable in at least one computing device, comprising:
code that accesses a first web service offered by an entity over a network to obtain payment history data for a user of a client device, the payment history data comprising at least information associated with a plurality of payments made by the user to the entity, the client device in data communication with the at least one computing device over the network;
code that generates a user interface to send to the client device comprising at least the plurality of payments for rendering a display of the client device;
code that receives user input comprising a selection of a subset of the plurality of payments, the user input obtained via the user interface rendered in the display of the client device;
code that authenticates the subset of the plurality of payments to verify each of the plurality of payments in the subset satisfied an obligation owed to the entity by the user;
code that generates a reporting document comprising at least the subset of the plurality of payments authenticated; and
code that transmits the reporting document over a second web service associated with a credit bureau.

2. The non-transitory computer-readable medium of claim 1, wherein the program further comprises code that generates a credit metric based at least in part on the plurality of payments authenticated.

3. The non-transitory computer-readable medium of claim 2, wherein the reporting document further comprises the credit metric.

4. A system, comprising:
at least one computing device comprising processing hardware in data communication with a client computing device over a network; and
a payment verification application executed in the at least one computing device, the payment verification application comprising:
logic that obtains payment history data for a user of the client computing device over the network via a first application programming interface, the payment history data comprising at least information associated with a plurality of payments made by the user to an entity;
logic that verifies that each of the plurality of payments satisfied an obligation owed to the entity by the user;
logic that generates a reporting document comprising at least the plurality of payments verified; and
logic that transmits the reporting document via an electronic communication medium to a computing device via a second application programming interface.

5. The system of claim 4, wherein the second application programming interface is associated with a credit agency.

6. The system of claim 4, wherein the payment verification application further comprises logic that generates a credit metric based at least in part on the plurality of payments verified.

7. The system of claim 4, wherein the reporting document further comprises the credit metric.

8. The system of claim 4, wherein the payment verification application further comprises logic that generates user interface data to send to the client computing device, the user interface data comprising data configured to generate a user interface comprising at least the plurality of payments.

9. The system of claim 8, wherein the payment verification application further comprises logic that receives user input comprising a selection of a subset of the plurality of payments, the user input obtained via the user interface rendered in the display of the client computing device.

10. The system of claim 9, wherein the payment verification application further comprises logic that authenticates the subset of the plurality of payments to verify each of the plurality of payments in the subset satisfied the obligation owed to the entity by the user.

11. The system of claim 10, wherein the reporting document further comprises at least the subset of the plurality of payments authenticated.

12. The system of claim 11, wherein the reporting document further comprises consumer identification information associated with the user.

13. A computer-implemented method, comprising:
obtaining, by at least one computing device comprising at least one hardware processor, payment history data for a user of a client device over a network, the payment history data comprising at least information associated with a plurality of payments made by the user to an entity;
verifying, by the at least one computing device, the plurality of payments to ensure that each of the plurality of payments satisfied an obligation owed to the entity by the user;
generating, by the at least one computing device, a reporting document comprising at least the plurality of payments verified; and
transmitting, by the at least one computing device, the reporting document via an electronic communication medium over the network to a receiving computing device associated with a credit bureau.

14. The computer-implemented method of claim 13, wherein the computing device is associated with a credit agency.

15. The computer-implemented method of claim 13, wherein the payment verification application further comprises logic that generates a credit metric based at least in part on the plurality of payments verified.

16. The computer-implemented method of claim 13, wherein the reporting document further comprises the credit metric.

17. The computer-implemented method of claim 13, wherein the payment verification application further comprises logic that generates user interface data to send to the client device, the user interface data comprising data configured to generate a user interface comprising at least the plurality of payments.

18. The computer-implemented method of claim 13, wherein the payment verification application further comprises:
logic that receives user input comprising a selection of a subset of the plurality of payments, the user input obtained via the user interface rendered in the display of the client device; and
logic that authenticates the subset of the plurality of payments to verify each of the plurality of payments in the subset satisfied the obligation owed to the entity by the user.

19. The system of claim 18, wherein the reporting document further comprises at least the subset of the plurality of payments authenticated.

20. The system of claim 19, wherein the reporting document further comprises consumer identification information associated with the user.
